(19) United States
(12) Patent Application Publication
(10) Pub. No.: US 2014/0214474 A1
(43) Pub. Date: Jul. 31, 2014

(54) AGGREGATION OF CUSTOMER REQUIREMENTS

(71) Applicant: Marcello Balduccini, Penfield, NY (US)

(72) Inventor: Marcello Balduccini, Penfield, NY (US)

(21) Appl. No.: 13/750,319

(22) Filed: Jan. 25, 2013

(51) Int. Cl. G06Q 10/06

(52) U.S. Cl. CPC G06Q 10/06315
USPC 705/7.25

(57) ABSTRACT

A method is disclosed for aggregating multiple customer quoting requirements and selecting appropriate production entities for product production and distribution. The method includes receiving data from a network of production entities, including at least production and distribution pricing grids; and receiving quoting requirements from a plurality of customers including at least product volumes, product specifications, and delivery time for producing and distributing a plurality of customer designated products. The method further includes using a processor and the multiple customer quoting requirements and at least the production and distribution pricing grids from the one or more production entities to produce one or more aggregations of customer orders that satisfy the customer quoting requirements and to concurrently select at least one production entity capable of fulfilling a selected aggregation based on at least one selection criterion and sending quotes to the multiple customers using the selected at least one production entity.

### CROSS REFERENCE TO RELATED APPLICATIONS

Reference is made to commonly assigned U.S. patent application Ser. No. ______ filed concurrently herewith, entitled “Activation of Media Product Aggregation Using Order History” by Marcello Balduccini et al; U.S. patent application Ser. No. ______ filed concurrently herewith, entitled “Production Capacity Management in Media Product Aggregation Systems” by Marcello Balduccini et al; U.S. patent application Ser. No. ______ filed concurrently herewith, entitled “Aggregation of Media Product Production and Distribution” by Marcello Balduccini et al; and U.S. patent application Ser. No. ______ filed concurrently herewith, entitled “Adjusting a Customer Catalog for Ordering Visual Media Products” by Kevin Gobeyn et al, the disclosures of which are incorporated herein in their entirety.

### FIELD OF THE INVENTION

The present invention relates to methods for aggregating customer requests for the production and distribution of custom products and services to enable collaborative group buying.

### BACKGROUND OF THE INVENTION

U.S. Patent Application Publication No. 20120084143 A1 “Optimal List-Price Mechanism Design for Multi-Level Device Click-Through in Targeted Print or Electronic Communication”, is directed to delivering at least one communication from an advertiser to a consumer or in other words for direct advertising. It refers to an “advertisement product”, which is defined as “on-demand printed or electronic communications”, and it employs the notion of a “demand curve” to evaluate the demand for certain products. However, this demand curve considers the current demand and is not intended to anticipate demand fluctuations. It also does not address the phenomenon, common in production scenarios, of the reduction of the per-unit price when the total units for an order increase. The demand curve simply provides a “count” of how many advertisers are willing to pay a given price. It does not provide an account of the past or permit one to consider seasonal or regional variations in demand, which are often important when trying to anticipate such demand fluctuations. Moreover, it does not in general permit one to form reliable predictions about the future. It simply describes what the offers are right now. The ability to anticipate demand fluctuations is also a feature of the present invention and thus, to overcome the above limitations, the notion of “historical demand model” is introduced, based on the use of pricing grids and order history.

It should be noted that a further shortcoming of the prior art reference is that it does not have contingencies for producing and distributing “non-advertising” products or services such as photo books, greeting cards, custom wall paper, and personalized and short run calendars, apparel, and the like.

A feature of the present invention is that it gives equal importance to production costs and distribution costs. In contrast, most of the current art attempts to only minimize production costs, either by selecting only low cost production entities and processes by using a bidding process where the lowest bid wins, or by modifying product requirements, such as using lower cost materials, lower quality processes, format changes, or reducing sizes.

Some production entities rely on a technique referred to as “contribution pricing”, as described in U.S. Pat. No. 6,397,197B1 “Apparatus And Method For Obtaining Lowest Bid From Information Product Vendors”, where they provide low or no margin pricing in order to keep their operation running at near capacity as opposed to enduring periods where their production equipment and staff are under-used or inactive. This form of pricing can alienate regular customers that pay the standard price and can negatively affect pricing in general. In addition, small volume “fill in” work is often disruptive to normal production, requiring changes to production set ups and procedures which also impacts costs and productivity. There is no competitive “bidding” used in the present invention, since prices are determined from production and distribution pricing grids. Aggregated requests are sent to the selected production entities based on compatibility between the production and distribution capabilities, as expressed by the pricing grids, and aggregated requests.

The present invention employs a form of “Collaborative Group Buying” instead of the above described “Competitive Bidding”. Competitive bidding places the burden on the production entities and will always force them to find ways to reduce costs which can negatively impact quality, service, and profitability. In contrast, by aggregating multiple customer product or service requests and distributing them amongst a pre-established network of production and distribution entities, collaborative group buying enhances operational efficiencies, reduces the required numbers of setups, and makes possible longer production runs, resulting in less equipment and staff idle time and disruption. Because the production entities are operating closer to full capacity, the per-unit production costs are reduced which can improve quality, service, and profitability.

U.S. Pat. No. 6,330,542 “Automated Internet Quoting and Procurement System and Process for Commercial Printing”, provides a Delivery Zip Code which is used to select the nearest available print provider given the criteria entered by the print buyer and to compute the freight charges. This technique relies on production entities that are located near the distribution destination in hopes of reducing distribution costs. The production entity that is within the selected range from the distribution destination and with the lowest production costs is chosen. The problem with this technique is that distribution costs do not necessarily increase monotonically or the productions entities closest to the distribution destination might not have the lowest distribution or production costs. For example, a production entity that is close to a private or public sector distribution hub as opposed to regional proximity to the destination would have greater access to lower cost distribution. In addition, a potential production entity might be located in a so called “Right to Work” state where lower cost and higher productivity non-union labor is readily available.

From a technical perspective, in order to simultaneously consider all of the factors involved in determining the appropriate production entity capable of producing and distributing a given aggregated set of customer requirements, procedural programming can be used to implement a reasoning system that takes all the production and distribution factors into consideration. However, this approach would involve a significant effort requiring tens of thousands of lines code, and the corresponding algorithms could have to be modified quite substantially whenever a new constraint or feature of the system is required.

On the other hand, an aggregation system implemented using declarative programming is more adaptable and can be more efficient as real world data and use cases are collected. At the same time, this type of approach still provides the potential to migrate from declarative programming techniques to ad-hoc algorithms implemented using procedural programming once the problem space is well understood, in order to achieve a further level of improvement.

U.S. Pat. No. 7,788,143B2 “System and Method for Competitive Pricing and Procurement of Customized Goods and Services”, describes a method for selecting a lowest bidding vendor from a plurality of vendors of a customized good or service. Vendor attributes from each of the plurality of vendors representing their respective capabilities but no distribution or pricing grids are provided. The vendor attributes or the invitation-for-bid, or both, are received through a web browser. The invitation-for-bid is compared to each of the vendor's attributes according to certain standard or optional selection criteria to produce a vendor selection pool of vendors qualified to bid on the job.

Each vendor in the vendor selection pool receives a vendor's invitation-for-bid. A bid is received from at least one vendor in the vendor selection pool, the lowest price bid is identified, the buyer is informed of the identity of the selected vendor, and solicited for approval of the selected vendor. Upon receipt of approval from the buyer, an order is issued to the selected vendor. The non-selected vendors in the selection pool are informed of the bid prices and of the selection results. The prior art system does not aggregate customer orders to produce higher volumes of similar products and services. This places an additional burden on the production entities, requiring shorter production runs, more set up time, and under-used production equipment, facilities, and staff. Also the prior art system does not simultaneously process customer requirements with at least production and distribution pricing grids.

### SUMMARY OF THE INVENTION

A method is disclosed for aggregating multiple customer quoting requirements and selecting appropriate production entities for product production and distribution, comprising:

receiving data from a network of production entities, including at least production and distribution pricing grids;

receiving quoting requirements from a plurality of customers including at least product volumes, product specifications, and delivery time for producing and distributing a plurality of customer designated products;

using a processor and the multiple customer quoting requirements and at least the production and distribution pricing grids from the one or more production entities to produce one or more aggregations of customer orders that satisfy the customer quoting requirements and to concurrently select at least one production entity capable of fulfilling a selected aggregation based on at least one selection criterion; and

sending quotes to the multiple customers using the selected at least one production entity.

These and other aspects, features, and advantages of the present invention will be more clearly understood and appreciated from a review of the following detailed descriptions of the preferred embodiments and appended claims, and by reference to the accompanying drawings.

The aggregator isolates the customer from the production entities and acts on behalf the customer reducing the level of involvement required by the customer. The pre-established network of production entities only needs to establish and maintain communications with the aggregator.

There are fewer job orders and billing requirements for the same volume of work for the production entities since they only have to interact with the aggregator and larger aggregated orders. Moreover, if the production entities are paid by the aggregator, then the billing and collection requirements of the production entities are reduced significantly.

By aggregating multiple customer product/service requests and distributing them amongst a pre-established network of production and distribution entities, operational efficiencies are enhanced, the required numbers of setups are reduced, and longer production runs are possible, resulting in less equipment and staff idle time and disruption. Because the production entities are operating closer to full capacity, the per-unit production costs are reduced.

The printing and publishing market is affected by the recent innovations in low-cost and service-provider price-subsidized handheld, portable devices with real-time wireless access to content via the internet and cellular networks. As a result long printing runs required for magazines, catalogs, newspapers, and the like are in decline. By providing a system that collects and aggregates multiple customer orders for similar products and services and distributes these aggregated orders to a pre-established network of production entities the operational efficiencies, quality, and service provided by the production entities are maintained in a consolidating market.

Members of the pre-established network of production entities are certified as part of an “on-boarding” process. The aggregator is unconcerned with the detailed capabilities and day-to-day operations of the production and distribution entities such as the types of equipment, maintenance schedules, ongoing training, staffing levels, facilities, and so on. The aggregator is concerned with the supported product types and formats, volume capacities, and services supported by the production entities and communicated via the production and distribution pricing grids production and distribution pricing grids and response times for requests for estimates where appropriate.

There is no competitive “bidding” used in the present invention. Prices are determined from production and distribution pricing grids. Aggregated requests are sent to the selected production entities based on compatibility between the production and distribution capabilities, as expressed by the pricing grids, and aggregated requests. The present invention employs a form of “Collaborative Group Buying” as opposed to the more common “Competitive Bidding”, which instead places the burden on the production entities and will force them to find ways to reduce costs. This often negatively impacts the range of products supported by the production entities. It also can decrease the quality of the products, the service provided or the profitability of the production entities.

### BRIEF DESCRIPTION OF THE DRAWINGS

The invention is more completely understood by considering the detailed description of various embodiments of the invention which follows in connection with the accompanying drawings. Referring now to the drawings in which like reference numbers represent corresponding parts throughout:

FIG. 1 is a flow diagram of the first embodiment of the present invention that illustrates of the process of activation of media product aggregation based on order history;

FIG. 2 is a flow diagram illustrating a simplified overview of the aggregation system of the present invention;

FIG. 3 is a flow diagram illustrating an overview of the aggregation system of the present invention, including requests for estimates and estimates;

FIG. 4 is a flow diagram of the second embodiment of the present invention that illustrates the process of evaluation of media product aggregations based on order history;

FIG. 5 is a flow diagram of the second embodiment of the present invention that illustrates the process of evaluation of media product aggregations based on order history, including request for estimates and estimates;

FIG. 6 is a flow diagram of the third embodiment of the present invention that illustrates the process of pricing modifications in media product aggregation systems;

FIG. 7 is a flow diagram of the fourth embodiment of the present invention that illustrates of the process of efficiency enhancement of product aggregation using declarative programming techniques;

FIG. 8 is a diagram illustrating an aggregation scenario that aggregates like products with different destinations;

FIG. 9 is a diagram illustrating an aggregation scenario that aggregates different products with the same destinations;

FIG. 10 is a flow diagram of the fifth embodiment of the present invention that illustrates a simple overview of the process of using aggregation to dynamically update customer facing catalog pricing;

FIG. 11 is a flow diagram of the fifth embodiment of the present invention that illustrates of the process of using aggregation to dynamically update customer facing catalog pricing;

FIG. 12 is a graphic illustrating the user interface for the quoting requirements database;

FIG. 13 is a graphic illustrating the user interface for the production pricing grid;

FIG. 14 is a graphic illustrating the user interface for the distribution pricing grid;

FIG. 15 is a graphic illustrating the user interface for the historical database;

FIG. 16 is a graphic illustrating the expected items on order data display;

FIG. 17 is a graphic illustrating the expected weight on order by destination data display;

FIG. 18 is a graphic illustrating the user interface for the total cost comparison; and

FIG. 19 is a graphic illustrating the aggregation dispersal report data display.

### DETAILED DESCRIPTION OF THE INVENTION

The aggregator stores historic information related to the timing, types, and volumes of prior completed customer quotes and uses the stored historic information to determine if the quoting requirements should be aggregated now or at some point in the future. This information can also be used to predict seasonal and regional variations in demand. For example, a resort or vacation destination will have increased demand for marketing communications, promotional materials, pamphlets, mementos, and souvenirs prior to and during the peak season. Purchasable memorabilia such as calendars, posters, post cards, totes, hats, t-shirts, and the like are often customized to incorporate colors, graphics, images, and text expressing the theme and points of interest of the local venues as is true for marketing communications for accommodations, local entertainment offerings, and recreational venues. The amounts, types, and distribution patterns of these marketing communications, promotional materials, mementos, and souvenirs are extrapolated from past orders and sales. Special holidays, social events, regional events, anniversaries, and celebrations, political campaigns, or any other recurring or planned event are used along with past production and distribution patterns to predict and anticipate demand.

In addition, demand forecasts can include simple “averages” of orders received on a daily basis, which are used to accumulate a history demand record and to identify patterns of demand. For example, a given product, such as custom postcard, typically is requested on a routine basis with unit volumes averaging 50 per day.

Other important aspects of the aggregator are the quoting and estimation deadlines, which will have to be considered in order to meet production and distribution deadlines. The quoting requirements are accumulated as long as there is enough time remaining to meet quoting, estimating, production, and distribution deadlines, and these deadlines are determined from the quoting requirements, the historical data, the production and distribution pricing grids, or combinations. In addition to historic demand data, data on the distribution locations can also be accumulated and used to predict a range of distribution costs that are anticipated and used to make more accurate and cost effective aggregations. This is accomplished using United States Postal Service (U.S.P.S.) ZIP codes or Postal Zone Charts, or any other standardized distribution table provided by a public or private distribution entity.

Production and distribution are provided by the same entity or by separate entities working collaboratively. Such would be the case of a commercial printer that uses U.S.P.S. for final distribution. The commercial printer provides presorted mail in approved containers based on the ZIP code destinations on the mail, in exchange for lower postage rates.

The U.S.P.S. also provides Business Mail Entry Units (BMEUs) which are areas of postal facilities where production entities present bulk and permit mail for acceptance. The BMEUs include dedicated platform space, office space, and a staging area on the postal workroom floor for use by production entities. The U.S.P.S. also provides Advance Deposit Accounts or “Trust Accounts” where a debit account is provided into which a production entity deposits funds that are maintained by the U.S.P.S. and from which postage is later deducted at the time of mailing.

As the described arrangements illustrate, the production entity can collaborate very closely with a distribution entity. In addition, with products that have standard formats and properties, such as post cards, business cards, calendars, photo books, photographic prints, catalogs, pamphlets, and CDs and DVDs, the shipping weights of these products are calculated directly from the product volumes using known unit product weights. The following U.S. Patent Nos. describe these techniques and are incorporated by reference: U.S. Pat. No. 6,943,867 B2 Method and System For Shipping Of Photofinishing Orders, U.S. Pat. No. 6,829,037 B2 Method and System For Verifying A Photofinishing Order, and U.S. Pat. No. 6,812,998B2 Method and System For Shipping Of Photofinishing Orders.

A production entity also referred to as a Production Service Provider or “PSP”, might be able to fulfill an order for 500 units by the production or distribution deadline but not an order of 5000 units. In addition, PSPs can specify multiple production and distribution time frames to accommodate special circumstances such as a premium priced “Rush Order”. These special circumstances can also be included in the pricing grids.

The following scenario is an illustrative example of a typical routine Annual Catalog Order from a regional retailer. For the previous 6 years “Acme Fine Apparel (AFA)” has had their annual Mother's Day Sale. 30 days prior to the sales event AFA has requested quotes for producing catalogs and distributing them via a bulk mailing to several target zip codes within a 10 mile radius of their 3 retail locations. In the first year AFA had one retail location and had requested quotes for 10,000 catalogs, but over the six year period the business had expanded to three retail locations and last year ordered 40,000 catalogs, each containing 12 full color pages with an inserted page of coupons. The prior years' orders were analyzed and according to the trend an order of between 40,000 and 45,000 catalogs, distributed to 3 zip code locations via bulk mail, and each containing 12 full color pages with an inserted page of heavy stock, pre-perforated coupons. This historic demand data is used by the aggregator to anticipate these order types, volumes, and distribution patterns and a time frame to expect to receive a request for quote from the potential customer.

Another example involves Seasonal Greeting Card Orders from individual customers. Each year for the past five years, at 6 weeks prior to the Christmas holiday, orders for holiday cards start to arrive. Each week the number of orders increases, peaking one week before Christmas and dropping to pre-holiday levels a week after Christmas. Individual orders range from between 25 cards (minimum order) to approximately 500 cards, with each order requesting selected digital art work.

TABLE 1

| Week | Number of Orders | Total Unit Volume | Average units/order |
|---|---|---|---|
| 1 | 50 | 11,250 | 225 |
| 2 | 125 | 24,375 | 195 |
| 3 | 300 | 72,000 | 240 |
| 4 | 625 | 137,500 | 220 |
| 5 | 1,060 | 275,600 | 260 |
| 6 | 15 | 2,625 | 175 |

Historical demand provides the basis of demand forecasting. Obviously, no demand forecasting technique is completely accurate so multiple approaches can be combined to augment or replace simple historic averages. Combining forecasting methods improves accuracy and reduces the chances of large errors.

There are many well-known demand forecasting techniques that are used within the present invention such as “Rule-Based Forecasting”, where normalized data is processed using short and long range models. For each of these two models, trends are identified; for the long range model, trends are dampened due to the greater uncertainty caused by the longer the time horizon. Results from both the short and long range models are then combined to obtain a rule-based demand forecast.

Another approach to demand forecasting is the use of mathematical models such as “Neural Networks” for modeling the complex relationships between historic information such as order quantity type and volume, previous sales, time of year, order locations, or delivery locations. Neural networks are advantageous in that they are adaptive systems that can change their structure during the learning phase of deployment.

“Data Mining” is another technique used for demand forecasting and involves semi-automatic or automatic analysis of large volumes of data to extract previously unknown patterns. Detected patterns include: groups of data records referred to as a cluster analysis, unusual records or anomaly detection, and dependencies know as association rule mining. These patterns are summaries of the accumulated historic data and are used to identify multiple groups in the historic data, which are then used to obtain more accurate demand forecasting.

“Causal Models” rely on the assumption that it is possible to identify the underlying factors that influence the value of a variable of interest. Forecasts based on linear relationships between identified variables that occur for long periods of time are useful in predicting such a relationship in the future. In addition, non-linear repeating patterns such as seasonality as previously described in the “Annual Catalog Orders” and “Seasonal Greeting Card Orders” examples can also be used with this technique. The “Time Series Projection” methods also use historical data as the basis of estimating future outcomes. These methods include “Simple Moving Average”, popular for instance in predicting stock market fluctuations, which relies on the arithmetically averaging of past data over a specified period to project forward in time in order to smooth out short term fluctuations and highlight long term trends or cycles. This is a very simple way to implement smoothing algorithm but is generally considered to provide low accuracy results.

Another Time Series Projection method is “Exponential Smoothing”, which is also a smoothing technique that is applied to time series data. This technique is used to smooth data or to make forecasts. Compared to the Simple Moving Average technique where past observations are weighted equally, exponential smoothing assigns exponentially decreasing weights over time.

Yet another Time Series Projection method is the “Trend Projection” method, which is focused on observing the magnitude and direction of the movement of a variable through time. This method requires reliable long term time series data.

The aggregator receives quoting requirements from customers and provides quotes to customers. In this sense, the aggregator acts as a liaison between are between customers and the production service providers (PSP). The aggregator also provides requests for estimates, derived from quoting requirements provided by the customers, to the production service providers and in response receives estimates from the PSPs. Quoting requirements and quotes reflect the price to be paid by the customer for products and services requested and requests for estimates and estimates reflect the price to be paid to the PSPs for the products and services provided.

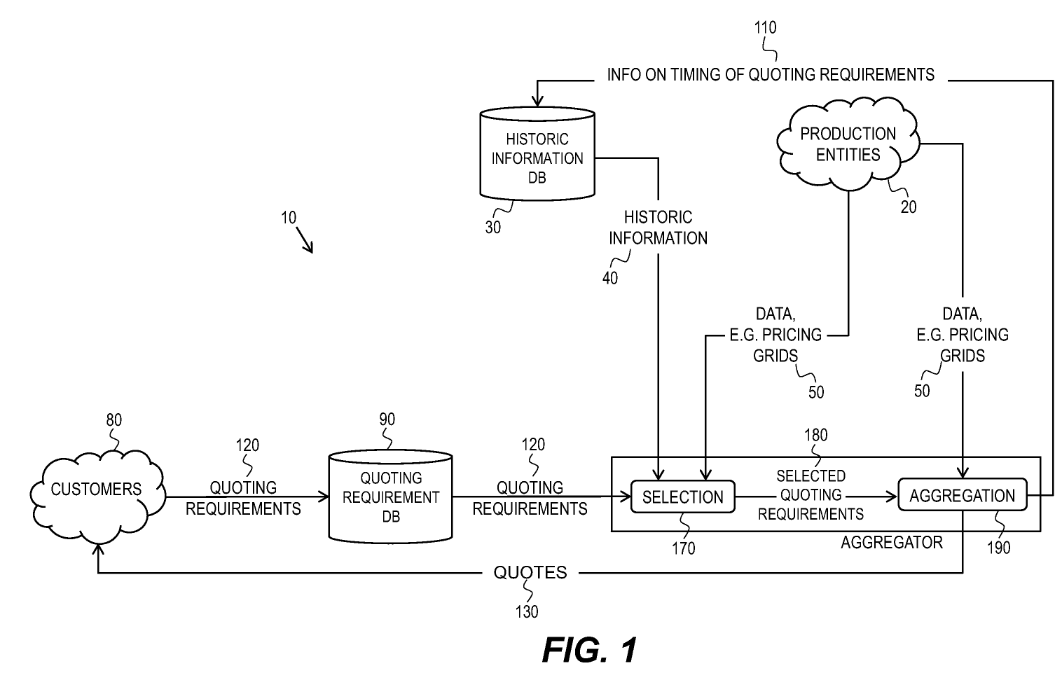

The first embodiment of the present invention provides a method for the activation of media product aggregation based on order history. FIG. 1 illustrates a process for determining if quoting requirements 120 (QRs), stored in quoting requirement database 90, should be aggregated now or in the future. The aggregator 10 receives data, including production and production/distribution pricing grids 50, from a pre-established network of production entities 20. The aggregator 10 also receives QRs 120 from a plurality of customers 80 for producing and distributing a plurality of customer designated products. The QRs 120 include quoting, production and delivery deadlines, product type, substrate type, or delivery destination. Finally, the aggregator 10 also retrieves historic information 40 from the historic information database 30 including information regarding the timing of prior completed customer quotes 110. Every time QRs 120 are received by the aggregator 10, the corresponding information is used to update the historic information database 30.

The above information is used by the selection component 170 in order to determine which QRs 120 are immediately forwarded to the aggregation component 190 and which ones are held for aggregation in the future.

Selection component 170 behaves as follows. First, based on historic information 40, the aggregator 10 determines the expected total volume, volume(p, m), of product p requested in QRs 120 received on a given day, and the expected average quoting deadline of such QRs 120. As previously described various demand forecasting techniques or combinations of those techniques are used.

Let daily_orders(p) denote the expected total volume of product p requested in QRs 120 received per day and let avg_deadline(p) denote the expected average deadline of such QRs 120. These values are obtained from the historic information database 30. Those skilled in the art will see that it is not difficult to extend the formulas below in order to consider different values of daily_orders(p) and avg_deadline(p) for each day. Intuitively, each of the QRs 120 that are expected for day i will become due avg_deadline(p) days after day i, and will have to be assigned. Therefore, the corresponding volume of product will no longer be on order.

Hence, the expected total volume of product p on order on day m (m≧0, with 0 meaning today) is:

$$volume ( p , m ) = volume ( p , 0 ) + k ( p , m ) - {\sum }_{0 \leq i < m} due ( p , i )$$

where volume(p, 0) is the quantity of product currently on order, due(p, i) is the total volume of product p in QRs 120 that have already been received by the system and due on day i, and

$$k ( p , m ) = \{ \begin{matrix}m \cdot daily\_orders ( p ) & if m < avg\_deadline ( p ) \\ avg\_deadline ( p ) \cdot daily\_orders ( p ) & if m \geq avg\_deadline ( p )\end{matrix}$$

A QR for product p is at peak for production on day D if on every day between today and the day the quote for QR is due, the expected volume on order for p is less than or equal to the volume on day D.

Next, historic information 40 and the received QRs 120 from quoting requirement database 90 are used by the aggregator 10 to determine the expected total shipment weight (weight (m, l), for a day m and a final destination l).

Let daily_orders_for_destination(p, l) denote the expected volume of product p in expected QRs 120 with final destination l and avg_deadline (p, l) be their expected quoting deadline. These values are obtained from the historic information database 30. Once again, those skilled in the art will promptly see how such estimates are made to depend on a given day.

The expected total shipment weight of product p for day m with final destination l, denoted by weight (p, m, l), is:

$$weight ( p , m , l ) = weight ( p , 0 , l ) + f ( p , m , l ) \cdot product\_weight ( p ) - {\sum }_{0 \leq i < m} due\_weight \_for \_dest ( p , i , l )$$

where weight (p, 0, l) is the weight of product currently on order, due_weight_for_dest (p, i, l) is the total weight of product p in QRs with destination l that have already been received by the system and due on day i, and

$$f ( p , m , l ) = \{ \begin{matrix}m \cdot daily\_orders \_for \_destination ( p , l ) & if m < avg\_deadline ( p ) \\ avg\_deadline ( p , l ) \cdot daily\_orders \_for \_destination ( p , l ) & if m \geq avg\_deadline ( p )\end{matrix}$$

The expected total shipment weight for day m and final destination l is then:

$$weight ( m , l ) = {\sum }_{p} weight ( p , m , l )$$

The QR 120 is at peak for mailing on day D if on every day between today and the day the quote for QR 120 is due, the expected shipment weight of the QRs 120 for the corresponding destination is less than or equal to the expected shipment weight on day D.

On any day D, the QR 120 can be at peak for production, for mailing, or for both. The system permits the operator to specify a preference order among the peaks. The preference order specifies which peak is better than another. The QR 120 is at an overall peak on day D if it is not expected to reach a better peak on any other day.

The QR 120 is at the latest overall peak on day D if it is at an overall peak on day D and it is not expected to be at an overall peak after day D.

Finally, the QR 120 is selected for aggregation on the current day by selection component 170 if it is currently at the latest overall peak. The set, 180 of QRs 120 that are selected for aggregation is then forwarded to aggregation component 190.

Those skilled in the art will see that selecting for aggregation the QR 120 when it is at the latest overall peak is appropriate when the frequency of withdrawal of QRs 120 by the customers 80 before their quoting deadline is expected to be low. Those skilled in the art will see how the selection criterion is modified to accommodate for more frequent withdrawals of QRs 120.

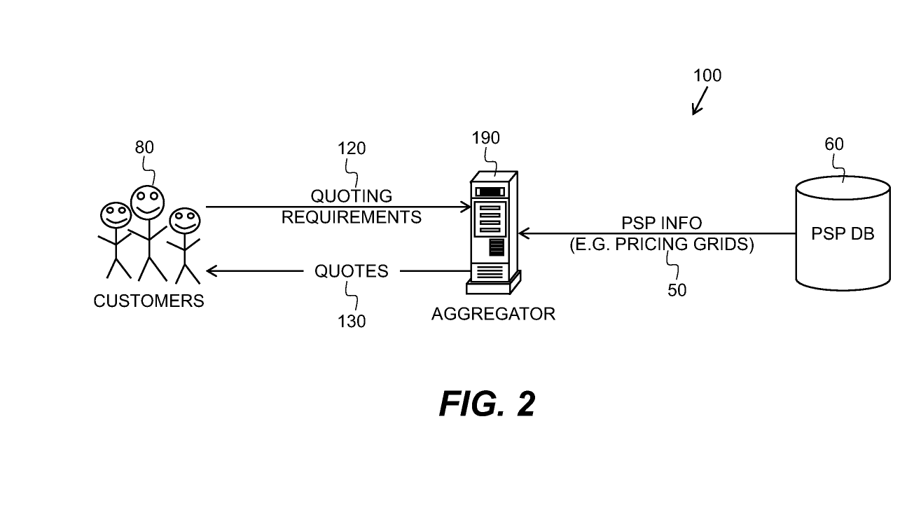

The second embodiment of the present invention provides a method of evaluation of media product aggregations based on order history. FIG. 2 illustrates an aggregator system overview without RFEs 100. Included in this overview are customers 80 that provide QRs 120 to the aggregation component 190. A production service provider or PSP database 60 provides the aggregation component 190 with information including production/distribution pricing grids 50 which along with the QRs 120 from quoting requirement database 90 are used to produce quotes 130.

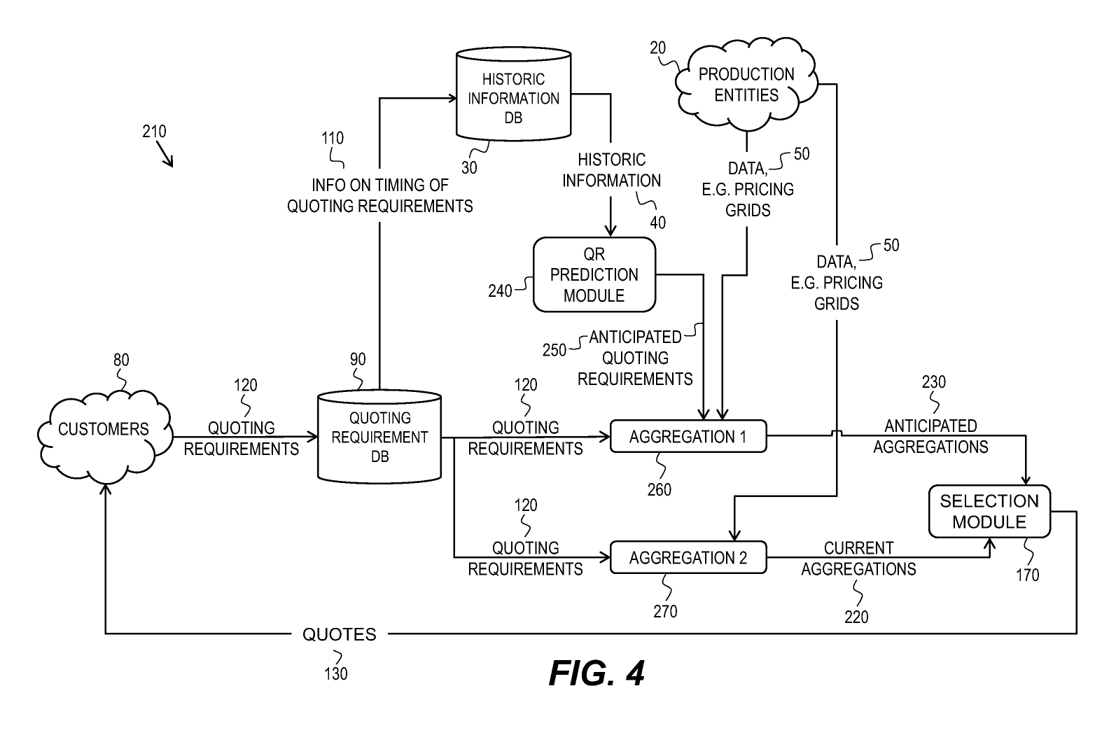

A more detailed explanation is provided by FIG. 4, which illustrates a method for aggregating media product production and distribution responsive to demand fluctuations. An aggregator 210 receives data, including production and production/distribution pricing grids 50, from a pre-established network of production/distribution entities 20. The aggregator 210 also receives QRs 120 from a plurality of customers 80 for producing and distributing a plurality of customer designated products. The QRs 120 include quoting deadlines.

Finally, the aggregator 210 also retrieves from the historic information database 30, information regarding the timing of prior completed customer quotes. Every time QRs 120 are received by the aggregator 210, the corresponding information is used to update the historic information database 30.

The above information is used by the selection component 170 in order to determine which QRs 120, should be processed immediately by the aggregator 210, and which ones should instead be held for aggregation in the future.

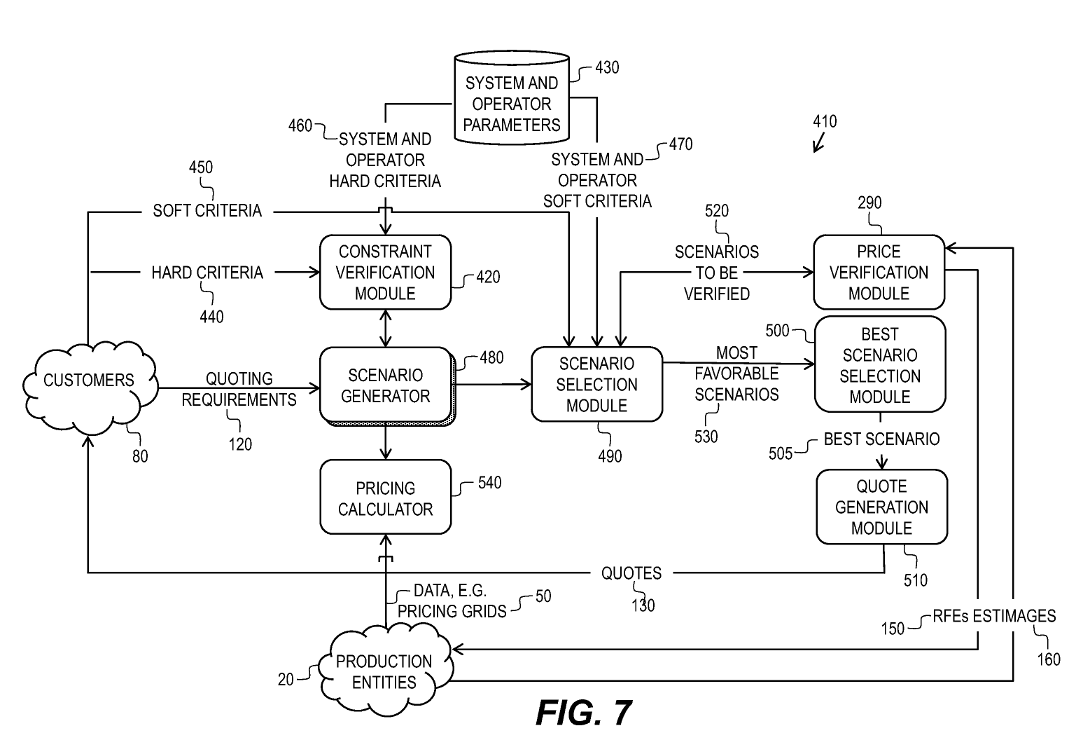

In this embodiment of the present invention, an aggregation component 2 270 computes aggregations of the QRs 120 received from the customers 80. The computation is performed under the assumption that the received QRs 120 will be processed immediately by the aggregator 210 (as opposed to being held for aggregation in the future). The aggregation task is performed as illustrated in FIG. 7, but those skilled in the art will recognize that alternative techniques for the computation of the aggregations can be applied. Concurrently, a QR prediction module 240 uses historic information 40 received from the historic information database 30 to produce an anticipated QRs 250, which are QRs that QR prediction module 240 predicts will be received in the future. An aggregation component 1 260 receives the existing QRs 120 and the anticipated QRs 250 and computes aggregations for them. The rationale of this step is to discover advantageous aggregations of existing QRs 120 that could arise if certain anticipated QRs 250 are indeed received. For example, consider a situation in which the existing QRs 120 include requests for a total of 1,000 pages of product p₁. The production prices listed by the production/distribution pricing grids 50 are for production entity e₁, and include a unit price of $0.90 for total order volumes of 1,500 pages or less, and $0.85 for order volumes of 1,500 to 10,000 pages. (For sake of simplicity in this example it is assumed that it is possible to identify a single production entity providing the lowest production prices for every possible quantity. In practice that is rarely the case, and the present invention is designed to deal with this more general case.) Given the existing QRs 120, there is no incentive to aggregate any of the QRs 120 for p₁, because every possible current aggregation 220 will yield a unit price of $0.90. On the other hand, suppose that historic information database 30 indicates that QRs 120 for a total volume of 750 pages of p₁ are expected to be received by the end of the day. The corresponding anticipated QRs 250 can thus be fed to aggregation component 1 260 together with the information about the current QRs 120. It is not difficult to see that aggregation component 1 260 can now find an anticipated aggregation 230 for p₁ with a total volume of 1,000+750=1,750 pages. This aggregation, if the anticipated QRs 250 are indeed received, gives access to the discounted unit price of $0.85 per page. In this example, then, it is advantageous to hold the current QRs 120 for p₁ and wait until the anticipated QRs 250 are indeed received—or until a determination is made that the current QRs 120 can no longer be held, for instance because their quoting deadlines are about to expire. The task of comparing current aggregations 220 and anticipated aggregations 230 and of making the determination whether any current QRs 120 should be held is made by selection component 170. To make this determination, selection component 170 calculates one or more scores for each of the current aggregations 220 and anticipated aggregations 230. The scores measure various aspects of the quality of the aggregations, including price, expected job quality, features of the corresponding production/distribution entities 20, features of the corresponding shipping methods, and timeliness (i.e. ability to match the deadlines). The scores are then compared using methods known in the art and the aggregations with advantageous scores are selected. When the selected aggregations belong to the set of anticipated aggregations 230, the corresponding current QRs 120 are put on hold. When the selected aggregations belong to the set of current aggregations 220, quotes 130 are produced for the corresponding current QRs 120 using the information from the selected aggregations. Finally, the quotes 130 are sent to the customers 80.

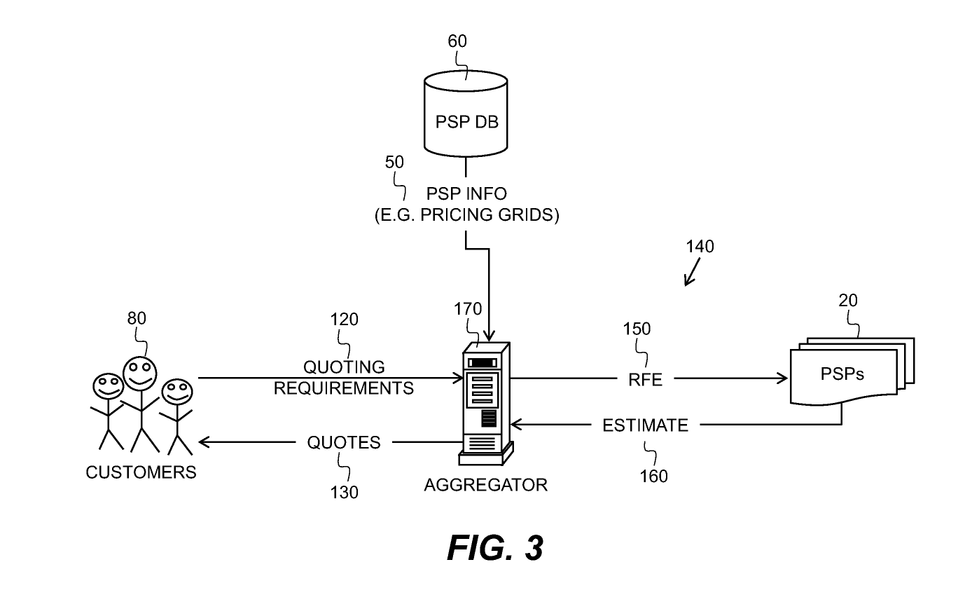

FIG. 3 illustrates an aggregator system overview with requests for estimates (RFEs) 140. Included in this illustration are customers 80 that provide quoting requirements or QRs 120 to the aggregator 140 and the PSP database 60 provides production/distribution pricing grids 50 to the aggregator 140. The aggregator 140 then sends RFEs 150 the network of production service providers also referred to as production/distribution entities 20 which intern provide estimates 160 to the aggregator 140. The aggregator 140 uses the estimates 160 to provide quotes 130 to the customers 80.

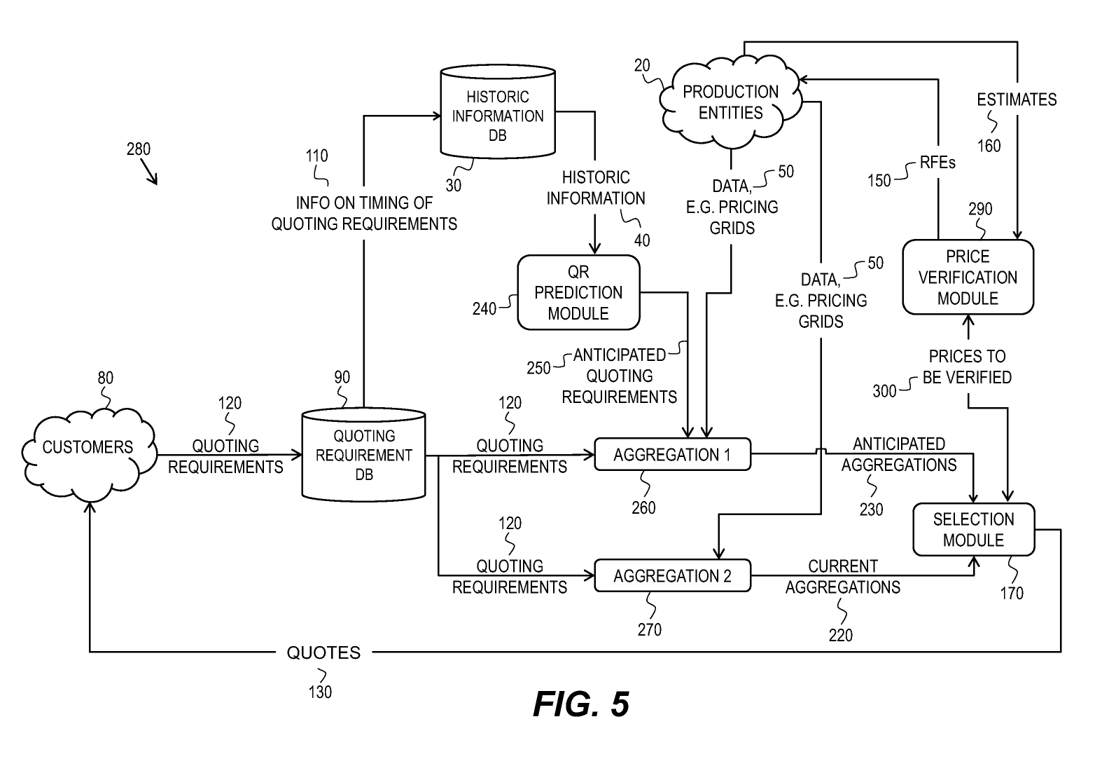

FIG. 5 provides detailed illustration of the aggregator system Overview with RFEs 140 and is an extension of the method from FIG. 4. An aggregator system 280 provides evaluations based on order history and RFEs 150 in which selection component 170 employs a price verification module 290 to verify the price estimates 300 contained in the current aggregations 220 and in the anticipated aggregations 230, obtained in turn from the pricing and production/distribution grids 50. The price verification module 290 will typically perform its task by sending suitable RFEs 150 to the production/distribution entities 20. This permits the production/distribution entities 20 to adjust the prices in response to sudden, temporary changes in the production environment, such as unexpectedly low demand. The production/distribution entities 20 are expected to respond to the RFEs 150 with estimates 160, which specify updated prices or alternative offers. It should be noted that giving the production/distribution entities 20 the ability to adjust their prices at this stage does not compromise the system's fairness. Of particular concern is preventing production/distribution entities 20 from entering unrealistic low prices in their pricing tables in order to be selected by the system, and then increasing the prices when the price verification module 290 requests estimates 160 from them. This situation cannot arise in the system described here, because the revised scenarios are re-ranked by selection component 170 after they are received from the price verification module 290.

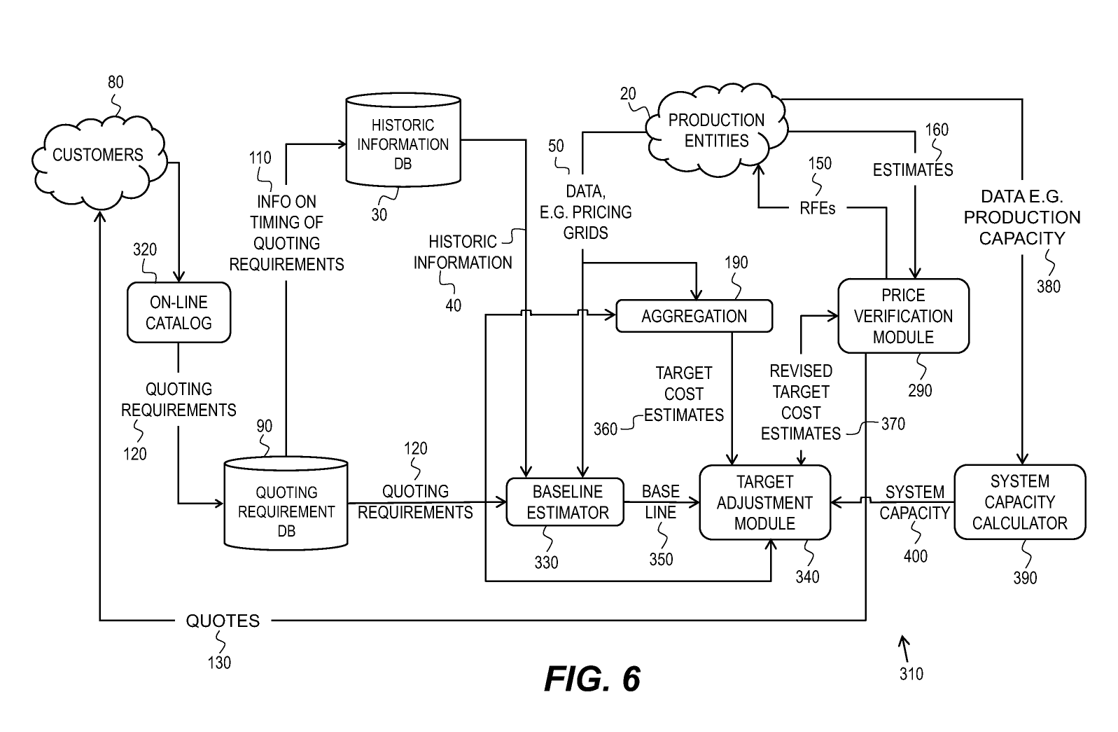

The third embodiment of the present invention provides a method of determining pricing modifications in media product aggregation systems. FIG. 6 illustrates a method for aggregating media product production and distribution responsive to demand fluctuations. The aggregator system with pricing modifications 310 receives data, including production/distribution pricing grids 50, from a pre-established network of production/distribution entities 20. The system 310 also receives QRs 120 from a plurality of customers 80 for producing and distributing a plurality of customer designated products, not shown.

The above information is used by a baseline estimator 330 to calculate a baseline of aggregated media product volumes 350 that are compatible with the capabilities and, optionally, with the capacities of the network of production/distribution entities 20. The baseline 350 provides target volumes of QRs 120 that should preferably be received from customers 80. For example, the baseline 350 can indicate the volume of QRs 120 that is needed to reach the largest cost savings based on production/distribution pricing grids 50 and on a system capacity 400 produced by a system capacity calculator 390. The system also retrieves from the historic information database 30 historic information 40 regarding the timing of prior completed customer quotes 110; the information is used to determine a baseline 350 indicating the volumes of QRs 120 that are typical for the current period of the year. In this embodiment, every time QRs 120 are received by the system, the corresponding information is also used to update the historic information database 30.

Concurrently, aggregation component 190 receives the current QRs 120 and the production/distribution pricing grids 50 from the production/distribution entities 20. The information is used to compute aggregations of the QRs 120 and to calculate corresponding initial quotes 130 for the QRs 120. In a preferred embodiment of the present invention, the aggregations are computed according to the method illustrated in FIGS. 1 and 7.

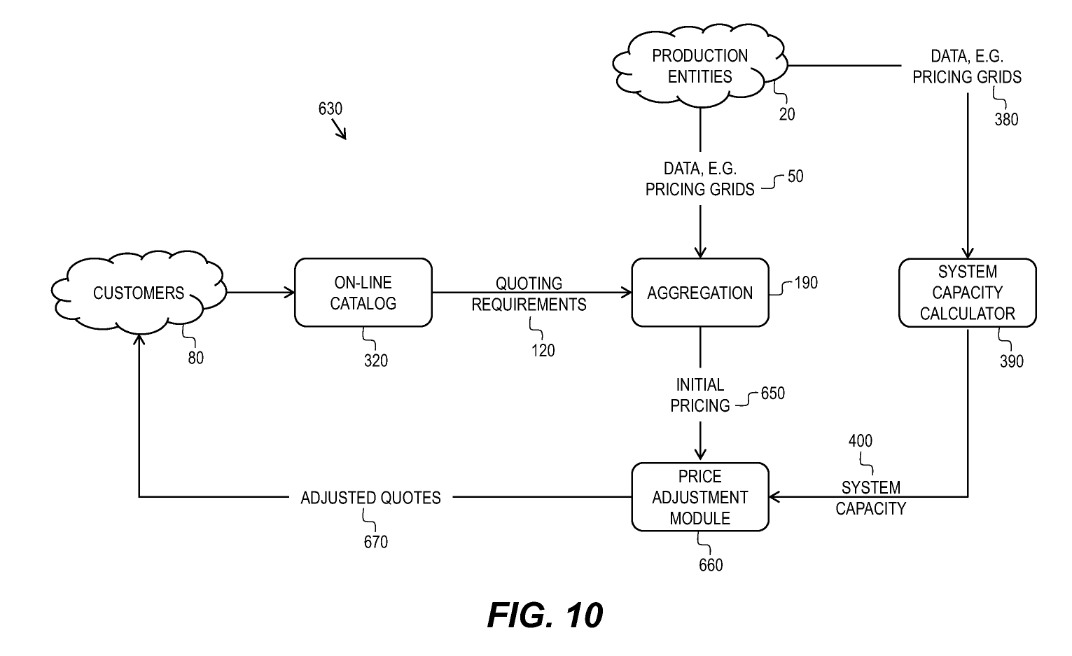

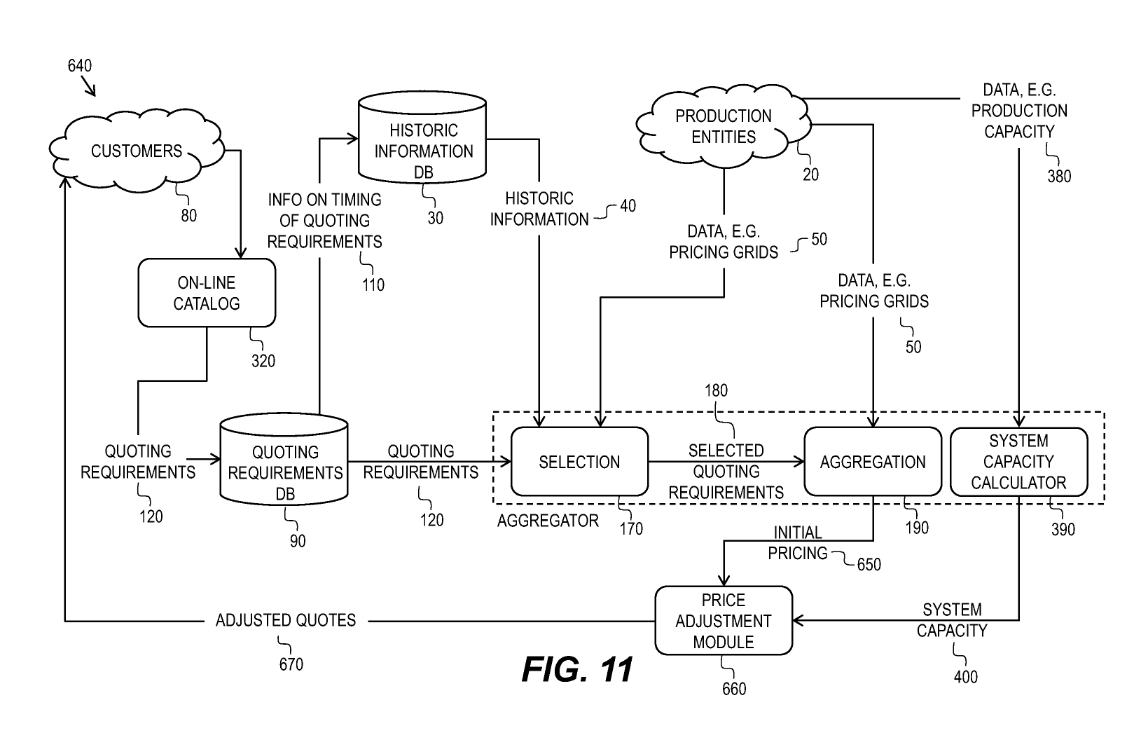

The quotes 130 are then received by a target adjustment module 340 together with the baseline 350 and the QRs 120. The quotes 130 include an indication of the corresponding unit price for each of the QRs 120, which represents a target cost estimate 360. Target adjustment module 340 compares the volumes of received QRs 120 with the baseline 350 of aggregated media product volumes 350. If the amount of QRs 120 is below the baseline 350, then the target cost estimates 360 from quotes 130 are reduced. Intuitively this is done in order to increase the chances that the customers 80 will accept the quotes 130. If the amount of QRs 120 is above the baseline 350, then the target cost estimates 360 from quotes 130 are increased, which prevents overwhelming the network of production/distribution entities 20. Corresponding revised target cost estimates 370 are then sent to the price verification module 290. In a preferred embodiment of the present invention, the computation performed by target adjustment module 340 also takes into account the current system capacity 400, as calculated by system capacity calculator 390 according to the method discussed in the description of FIG. 10 and FIG. 11. For example, in case of transient drops of the current system capacity 400, the target adjustment module 340 can force an increase in the target cost estimates 360 from quotes 130 in order to limit the volume of new orders.

Next, revised target cost estimates 370 are sent to the price verification module 290. The price verification module 290 confirms the revised target cost estimates 370 with the production/distribution entities 20, by sending to the production/distribution entities 20 suitable RFEs 150 and receiving corresponding estimates 160, as discussed in more detail in the description of FIG. 7. As a result of the receipt of the estimates 160, the price verification module 290 can determine that the unit prices 300 should be modified further in order to make them acceptable to the production/distribution entities 20. The determination is based on the actual cost estimates included in the received estimates 160. Once no further modification are required, the price verification module 290 calculates customer prices 300 for the customers 80 for producing and distributing customer designated media products based on such actual cost estimates. The corresponding quotes 130 are then sent to the customers 80.

In order to ensure fairness towards the production/distribution entities 20, in a preferred embodiment of the present invention, the price verification module 290 selects the set of production/distribution entities 20 that should receive RFEs 150 according to information about the timing about past RFEs 150 and depending on how the target adjustment module 340 has revised the target cost estimates 360. If the revised target cost estimates 370 are lower than the target cost estimates 360 from the quotes 130 produced by Aggregation component 190, then production/distribution entities 20 are selected, which have not received RFEs 150 with reduced cost estimates for a predetermined period of time. Alternatively, the production/distribution entities 20 are selected in sequential order. On the other hand, if the revised target cost estimates 370 are higher than the target cost estimates 360 from the quotes 130 produced by aggregation component 190, then production/distribution entities 20 are selected, which have not received RFEs 150 with increased cost estimates for a predetermined period of time. As above, the production/distribution entities 20 can also be selected in sequential order. This method ensures that production/distribution entities 20 with suitable capabilities are queried in a fair way, preventing the aggregator system 310 from sending RFEs 150 involving increased cost estimates always to the same production/distribution entities 20, which would receive an unfair advantage. Similarly, this method also prevents the system from sending RFEs 150 involving reduced cost estimates always to the same production/distribution entities 20.

The fourth embodiment of the present invention provides a method for efficiency enhancement of product aggregation using declarative programming techniques. FIG. 1 illustrates a process for aggregating multiple customers QRs 120 and selecting appropriate production/distribution entities 20 for product production and distribution. Aggregation component 190 receives data, including production and production/distribution pricing grids 50, from a pre-established network of production/distribution entities 20. The system also receives QRs 120 from a plurality of customers 80 for producing and distributing a plurality of customer designated products. The QRs 120 include an indication of the requested product volumes, product specifications, delivery destinations and deadlines of the various quoting, production or shipping processes. Without loss of generality, in the description that follows, it is assumed that each QR 120 specifies a single product type and a single delivery destination. The QRs 120 can also include additional information such as customer-specified selection criteria, in the form of preferences and constraints, production methods, about production/distribution entities 20, production locations, shipping methods. The criteria provided are either hard, meaning that they must be satisfied, or soft, meaning that they should be satisfied if possible. The system can also have system-provided or operator-provided selection criteria, again hard or soft; an example of system-provided criteria are those regarding contractual agreements with customers and production entities, which regulate quality of service or penalties for late deliveries. Operator-provided criteria are used to adjust to sudden changes in the production and shipping environment, such as weather-related disruptions of shipping routes due or financial problems of certain production/distribution entities 20.

In addition, the production/distribution pricing grids 50 provided by the pre-established network of production/distribution entities 20 includes additional information about the production/distribution entities 20 that can be important to potential customers. This ancillary information about the individual production/distribution entities 20 includes various business and industry designations such as minority owned status, women owned status, exclusive customer relationships, environmental compliance status, unionized workforce, non-unionized workforce, ISO certification, and energy efficiency designation. Customers 80 can request, via their QRs 120, that one or more of these selection criteria be used in selecting an appropriate production/distribution entity 20. The production/distribution pricing grids 50 provided by the pre-established network of production/distribution entities 20 also includes available substrate types and substrate width capacities. This information is useful for determining production capacities and for determining the types and the range of custom products that are produced.

In FIG. 1, the QRs 120 received by the aggregation component 190 are shown to have been initially filtered in order to determine which ones should be aggregated now and which ones should be aggregated in the future. Those skilled in the art understand that this filtering step is optional and can be performed in a variety of ways. The particular filtering method used, if any, does not affect the process performed by the aggregation component 190.

The above information is used by the aggregation component 190 in order to determine (1) which QRs 120 are assigned to a common production/distribution entity 20 in the form of a single order, rather than separate orders, in order to increase production and shipping volumes and receive better per-unit prices from the production/distribution entity 20; (2) which production/distribution entities 20 should receive the aggregated orders. These two steps are listed separately in this description of the aggregation component 190. Nonetheless, the two steps above can occur sequentially or in parallel, without affecting the present invention.

Let us introduce some terminology. Let Q be the set of QRs 120 that have to be processed by the aggregation component 190. An aggregation is a set A⊂Q such that the QRs 120 in A are assigned to a single production/distribution entity 20. An aggregation scenario (scenario for short) is a set S of aggregations from Q such that (1) the aggregations in S are pair wise disjoint; (2) every QR 120 from Q occurs in some aggregation in S; and (3) no two aggregations in S are assigned to the same production/distribution entity 20. The task of the aggregation component 190 includes (1) determining a set of scenarios and (2) identifying among those the most favorable one or ones, according to pricing, customer, system and operator selection criteria, and other system parameters as appropriate. When the system involves a human operator who is in charge of making the final decision it is appropriate to return multiple aggregation scenarios. The operator can then consider factors that are unknown to the aggregation component 190 when making the final decision. When the system acts without the intervention of a manual operator, it is more appropriate to identify a single most favorable scenario. The above two tasks can occur sequentially or in parallel, without affecting the present invention.

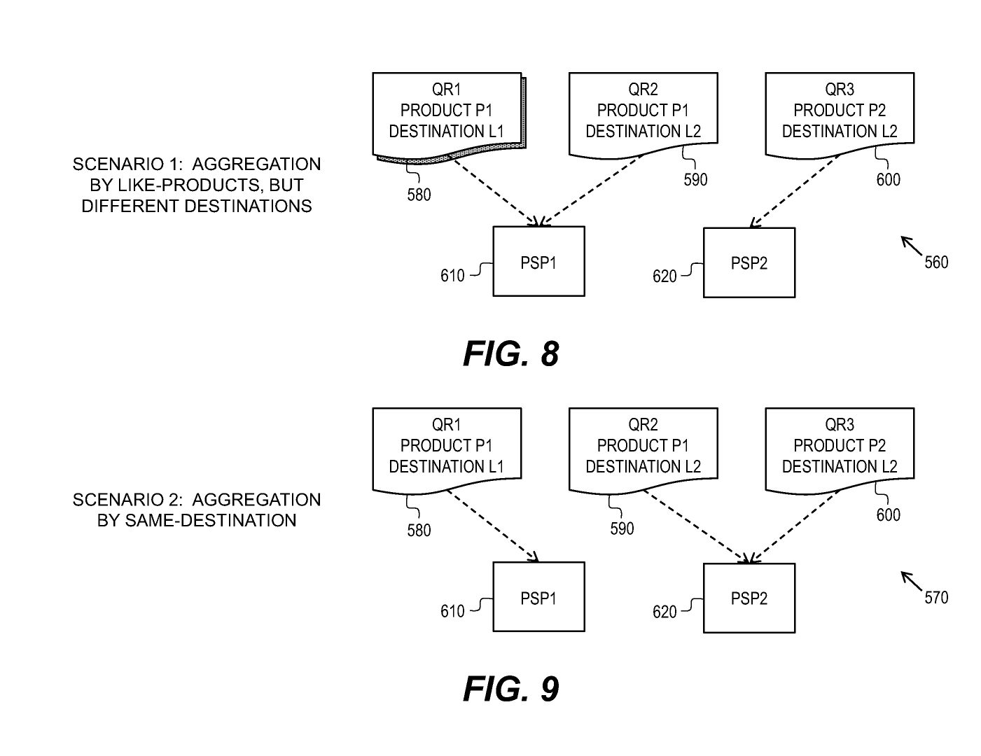

Those skilled in the art will promptly notice that many alternative aggregation scenarios for a given set of QRs 120 are possible. FIG. 8 and FIG. 9 illustrate two simple alternative scenarios for 3 QRs. FIG. 8 depicts aggregation scenario 1 560 contains an aggregation in which two QRs, 580 and 590, are aggregated and assigned to production entity 610. This aggregation is viewed as “like-product” aggregation, because the two QRs 580 and 590 are for the same product type p1. Such an aggregation can be advantageous if the production pricing tables of production entity 610 lists a lower per-unit production price for the order volume of combined QR 580 and QR 590 than for the volumes of the individual QRs. QR 600 is not combined with the previous QRs 580 and 590 because it is for a different product type p2.

The second case from FIG. 8 and FIG. 9 contain a “same-destination” aggregation scenario 2 570 depicted in FIG. 9, in which the QRs that are aggregated, 590 and 600, have the same destination. Such an aggregation can be advantageous if the shipping pricing tables of production/distribution entity 620 list a lower per-unit shipping price, for destination 12, for the total weight of combined QR 590 and QR 600 than for the weights of the individual QRs. Even in this simple example, many other aggregation scenarios are possible, and which ones are the most favorable depends on the system's parameters, such as the pricing tables and the customer-provided selection criteria. It should also be noted that certain aggregations might not be viable because of the selection criteria or because of limitations of the production entities. In fact, the underlying decision problem is of such complexity that significant inter-dependencies can exist among the aggregations of a scenario. This can lead for example to situations in which certain QRs cannot be aggregated together, and assigned to a certain production/distribution entity, if a certain aggregation is part of the scenario. For example, QRs from competing firms should not be processed at the same time by production/distribution entities belonging to the same owner.

FIG. 7 illustrates a block diagram of an aggregator system detailed overview 410 including scenario generator 480, which receives the set of QRs 120 to be aggregated, either directly from the customers 80 or from the selection component 170 of FIG. 1. Scenario generator 480 uses the set of QRs 120 to produce candidate aggregation scenarios. For each aggregation scenario produced, the pricing calculator 540 computes the corresponding prices based on information obtained from the production/distribution entities 20. Either concurrently or sequentially, the constraint verification module 420 verifies that the hard selection criteria customer hard selection criteria 440 and the system and operator hard selection criteria 460 are satisfied by the scenarios produced by scenario generator 480. These selection criteria can be provided by the customers 80 or by system and operator provided parameters 430, or both. Finally, a scenario selection module 490 evaluates the scenarios produced by scenario generator 480 and determines the set of most favorable scenarios 530, based on soft selection criteria including customer soft selection criteria 450 and system and operator soft selection criteria 470 obtained from the customers 80 as well as from system and operator parameters 430.

Optionally, scenario selection module 490 can send select scenarios as scenarios to be verified 520 to the price verification module 290 in order to determine accurate prices for the aggregations contained in those scenarios. The updated scenarios returned by the price verification module 290, if any, are then used by the scenario selection module 490 for the ranking of the scenarios. The price verification module 290 will typically perform its task by sending suitable requests for estimates (RFEs) 150 to the production/distribution entities 20. This permits the production/distribution entities 20 to adjust the prices in response to sudden, temporary changes in the production environment, such as unexpectedly low demand. The production/distribution entities 20 are expected to respond to the RFEs 150 with estimates 160, which specify updated prices or alternative offers. It should be noted that giving the production/distribution entities 20 the ability to adjust their prices at this stage does not compromise the system's fairness. Of particular concern is preventing production/distribution entities 20 from entering unrealistic low prices in their production/distribution pricing grids 50 in order to be selected by the system, and then increasing the prices when the price verification module 290 requests estimates 160 from them. This situation cannot arise in the system described here, because the revised scenarios are re-ranked by scenario selection module 490 after they are received from the price verification module 290.

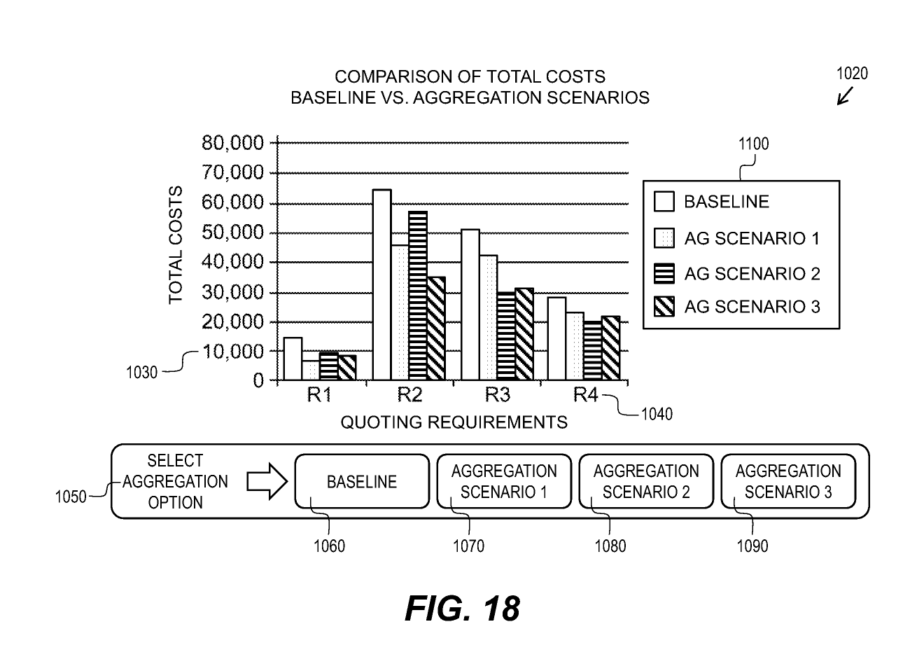

Next, the best scenario selection module 500 selects a best scenario 505 from the most favorable scenarios 530. In the simplest case, the selection is performed manually by an operator, as shown in FIG. 18 depicting the user interface for the total cost comparison. Alternatively, the selection is performed in an automated manner, for example by selecting the highest ranked scenario from the set of most favorable scenarios 530.

Finally, the best scenario 505 is used by quote generation module 510 to prepare and send quotes to the customers 80. The challenge of the task performed by quote generation module 510 is in spreading in a fair manner the savings obtained by the aggregations in the best scenario 505. A simple approach in determining a per-unit price from each aggregation of the scenario is to obtain a price for each QR 120 in the aggregation by multiplying the per-unit price by the volumes specified in that QR 120. Margins and fees can also be added, for example as a percentage or as fixed values. In this approach, the savings obtained by aggregating the QRs 120 are spread equally throughout the aggregated QRs 120. A possible alternative approach would be to assign to each QR 120 an amount of savings that is proportional to the volumes specified in that QR 120. This permits customers to be awarded cost savings that are proportional to how much their QRs 120 have “contributed” to achieving the overall cost savings. Customers 80 with the largest-volume QRs 120 in an aggregation would receive the largest savings; customers with smaller-volume QRs 120 would receive smaller savings, but they would still save money compared to the rates they would have received on their own. The quotes are then sent to the customers 80.

It should be noted that, in order to reduce the amount of scenarios considered by aggregation component 410, and thus improve performance, it is possible and often advisable to execute some of the modules in FIG. 7 concurrently, and to perform some of the tests on partial scenarios rather than on complete scenarios. This technique is well known in the art, especially in the literature on Constraint Programming, Boolean Satisfiability and Answer Set Programming, and will not be discussed further.

The fifth embodiment of the present invention provides a method for using the aggregator to dynamically update customer facing catalog pricing. FIG. 10 illustrates aggregator system with dynamically updated catalog pricing 1 630 which provides a method for adjusting customer pricing for the production and distribution of visual media based on system capacity. The system receives data, including production/distribution pricing grids 50 and information about production capacity 380, from a pre-established network of production/distribution entities 20. The system also receives QRs 120 from a plurality of customers 80 for producing and distributing visual media products selected from an on-line catalog 320.

The above information is used by aggregation component 190 to compute aggregations of QRs 120 and calculate a corresponding initial pricing for QRs 120. In a preferred embodiment of the present invention, the aggregations are computed according to the method illustrated in FIG. 1 and FIG. 7. Concurrently, system capacity calculator 390 uses the production capacity information 380 to compute the system capacity 400. System capacity 400 gives an indication of the amount of orders production/distribution entities 20 are still capable of accepting without disrupting production. In a preferred embodiment of the present invention, system capacity calculator 390 provides a distinct value of system capacity for each type of product listed in on-line catalog 320. In simple embodiments of the present invention, given a set PE, representing the network of production/distribution entities 20, the system capacity 400 for product p, denoted by SC(p), is computed as:

$$S C ( p ) = {\sum }_{e ∈ PE} capacity ( e , p )$$

where capacity(e, p) denotes the capacity of production entity e for product p, measured in terms of the volume of orders for p that e can still accept. In another preferred embodiment of the present invention, system capacity 400 for product p is calculated by taking into account the influence of existing orders for products different from p. Consider for example the case of a production entity e₁ that has a single press capable of producing product p and some other product p′. If the press is already in use for the production of a large order for product p′, then capacity(e₁, p) is lowered accordingly. Such adjustment can be performed in several ways. In one such method, fixed coefficients are provided to the system. A coefficient α(p′, p) indicates how much the current production of p′ affects the capacity of p. The initial value of capacity(e₁, p) can then be lowered by α(p′, p)·volume(e₁, p′), where volume(e₁, p′) is the volume of product p′ already on order. Another method for adjusting the capacity takes into account the deadlines of the orders. For example, the production of an order that is scheduled to be completed in the next one or two days is unlikely to overlap with the production of an order that is currently quoted. An adjusted value of capacity(e₁, p) can thus be obtained by taking into account the existing orders that are due at least k days in the future, where k is a system parameter that acts as a threshold. In yet another embodiment of the present invention, system parameters including α(p′, p) and k are computed using machine learning and data-mining techniques, known in the art, such as neural networks.

Given the initial pricing 650 and the system capacity 400, a price adjustment module 660 adjusts the unit pricing in response to the system capacity 400 and sends correspondingly adjusted quotes 670 to customers 80. In a preferred embodiment of the present invention, the price adjustment module 660 reduces the prices when system capacity 400 is high, in order to attract orders, and increases the prices when system capacity 400 is low. Capacity thresholds c_{low} and c_{high} specify which beyond which values system capacity 400 should be considered, respectively, low or high. Coefficients adj_{iow} and adj_{high} specify by which percentage prices should be decreased or increased depending on the system capacity 400. In another embodiment of the present invention, the amount of the price adjustment is proportional to the difference between the system capacity 400 and the corresponding capacity threshold. In yet another embodiment of the present invention, the initial pricing 650 obtained from aggregation component 190 includes a margin charged for the aggregation task. The price adjustment performed by price adjustment module 660 modifies the margin component of the initial pricing 650, as described earlier. In another embodiment of the present invention, the margin and non-margin components of the initial pricing 650 are adjusted in different proportions, according to coefficient provided to the system.

FIG. 11 illustrates an aggregator system with dynamically updated catalog pricing 2 640, a preferred embodiment of the present invention in which early in the process, a determination is made as to which QRs 120 should be aggregated now and which ones should be aggregated in the future. Similarly to the process of FIG. 1, data from the historic information database 30 provides an indication regarding the timing of prior completed customer quotes 110. As discussed earlier, that information is used by the selection component 170 to determine which QRs 120 should be forwarded to the aggregation component immediately, and which ones should instead be held for aggregation in the future.

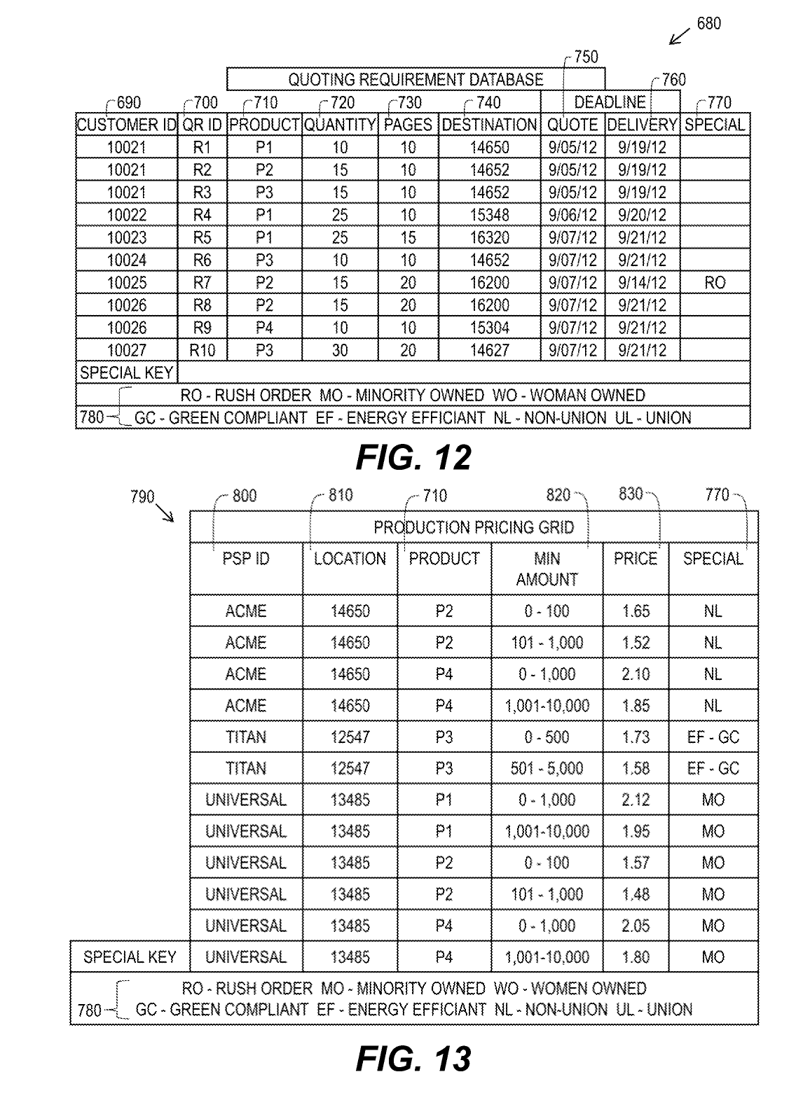

FIG. 12 is a graphic illustrating the user interface (UI) for the quoting requirements database 680. customer ID data 690 is presented in the first column and each customer 80 is assigned a sequential number by the system. Other conventions for identifying the customer 80 such as reusable, customer specific ID are used as long as they are consistent with the aggregators goal to monitor and record the customers current and historic quoting requirements. The specifics of quoting requirements ID data 700, such as product type data 710, product quantity data 720, page quantity data 730, destination data 740, which is expressed a U.S.P.S. Zip Code, quote deadline data 750, and quote delivery data 760, are presented in the subsequent columns and are also monitored and recorded for current use to fulfill customer 80 quoting requirements and to be used to forecast demand in the future. The additional details regarding the customer and customer location are provided directly on the UI 680, or made available to the operator for example by selecting the box of interest with a mouse, touch screen or other pointing device that are well known in the art and thus not shown. In addition special data 770, as previously described, representing soft and hard constraints such as minority owned status, women owned status, or exclusive customer relationships as required by the customer 80, are presented in the final column. The code key representing special data 770 is provided a data key 780 at the bottom of the UI 680. UI 680 provides the operator, not shown, of the aggregator system with a simple, easy to read status of the number and details of the quoting requirements currently in the system.

FIG. 13 is a graphic illustrating the User Interface for a production pricing grid 790. Production entity ID data 800 uses the name of the production entity since the network of production entities does not change on a frequent or routine basis. Production entity location data 810, as with the customer destination data 740, shown on FIG. 12, uses U.S.P.S. Zip Codes for convenient “at a glance” comparisons. Also as with FIG. 12 additional details regarding the production entity and production entity location can be provided directly on the UI 790 or are available to the operator for example by selecting the box of interest with a mouse, touch screen or other pointing device. Product type data 710 is expressed as a product code, a product name or as product details as previously described, and are accessed by selecting the product of interest with the use of a pointing device. Each product is provided with order amount data 820, which shows the volume ranges of each supported product, and with pricing data 830. Together the order amount data 820 and pricing data 830 illustrate the products supported by each production entity and the volume dependent pricing for each product.

In addition special data 770 as previously described, representing soft and hard constraints such as minority owned status, women owned status, or exclusive customer relationships supported by each individual production entity, are presented in the final column. The code key representing special data 770 is provided by data key 780 at the bottom of the UI 790. UI 790 provides the operator, not shown, of the aggregator system with a simple, easy to read representation of the production/distribution pricing grids 50 provided by the production/distribution entities 20.

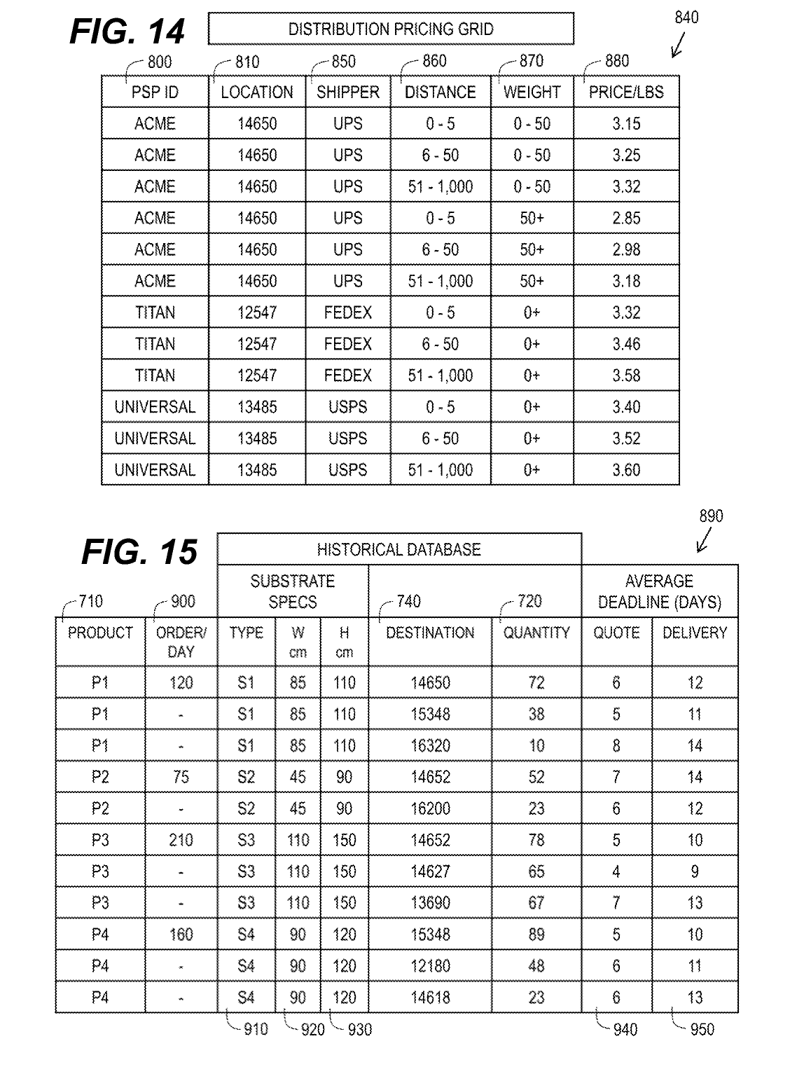

FIG. 14 is a graphic illustrating the user interface for the distribution pricing grid 840. As previously discussed, the production entity and distribution entity are the same or separate collaborating entities. A shipper type data 850 shows the names of the preferred shippers used by each production/distribution entity 20. Each production/distribution entity 20 has a production entity ID data 800 as used in the production pricing grid illustrated in FIG. 13. The production entity location data 810 uses U.S.P.S. Zip Codes for convenient “at a glance” comparisons. Additional details regarding the production/distribution entity 20 and production/distribution entity 20 location are provided directly on the UI 840 or are available to the operator for example by selecting the box of interest with a mouse, touch screen or other pointing device. Distance range data 860 together with weight range data 870 provides price per weight data 880.

FIG. 15 is a graphic illustrating the user interface for the historical database 890. Included in the historical database UI 890 product type data 710, product quantity data 720, destination data 740, and orders per day data 900 which provide an overview used to monitor volumes, types, and destinations of orders received on a daily basis over time. Additional product details such as substrate type specification data 910, substrate width specification data 920, and substrate height specification data 930 are also provided in order to communicate back to the production entities so that they can stock the appropriate substrates to support future orders. In addition average quote deadline data (days) 940 and average delivery deadline data (days) 950 are provided in order to monitor that quotes and deliveries are fulfilled in a timely manner.

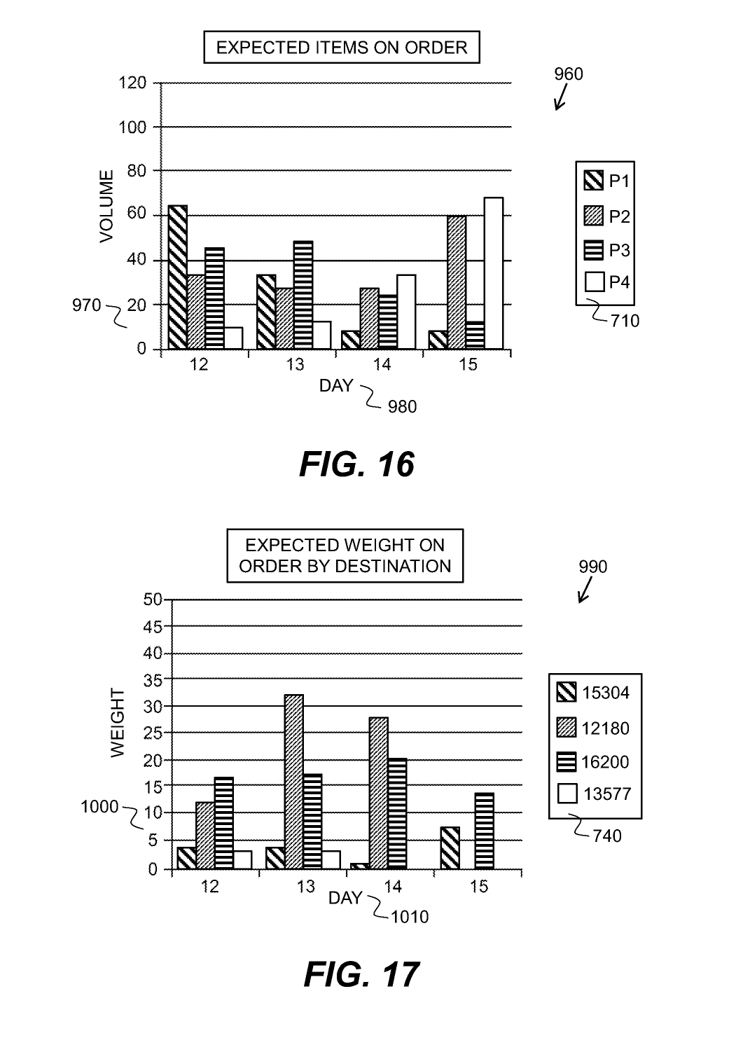

FIG. 16 is a graphic illustrating the expected items on order data display 960 and represents the forecasts provided from historic information 40 stored in the historic information database 30 as illustrated FIG. 1. A volume axis 970 and a day axis 980 together show the amounts of expected orders for the various products, as expressed in this example by product type data 710, over time.

FIG. 17 is a graphic illustrating the expected weight on order by destination data display 990 and represents the forecasts provided from historic information 40 stored in the historic information database 30 as illustrated FIG. 1. A weight axis 1000 and a day axis 1010 together show the weights of expected orders for the various destinations, as expressed in this example by U.S.P.S. Zip Codes destinations 740, over time.

FIG. 18 is a graphic illustrating the user interface for a total cost comparison 1020 which is used in situations where the operator of the aggregator system wants to override automatic aggregation and make a manual selection of potential aggregations. Provided on total cost comparison user interface 1020 are a total cost axis 1030, which represents the combined production and distribution costs, and a quoting requirements axis 1040, representing the received quoting requirements. In the graphic shown on total cost comparison user interface 1020 is a bar chart but any other suitable well-known data representation graphic such as a stacked bar, line, or column chart can be substituted for the bar chart. An aggregation scenario key 1100 provides guide for the operator to interpret the aggregation scenarios presented on total cost comparison user interface 1020. an aggregation option selection bar 1050 includes a baseline selection icon 1060, aggregation scenario 1 icon 1070, an aggregation scenario 2 icon 1080, and an aggregation scenario 3 icon 1090. The baseline option 1060 represents the costs for fulfilling a quote without aggregation. After reviewing the total cost comparison user interface 1020 the operator selects one of the aggregation options from the selection bar 1050 with a mouse, touch screen or other pointing device that are well-known in the art, and thus not shown. Alternatively, the total cost comparison user interface 1020 is also used to monitor automatic aggregation selection. In this case the aggregation option selection bar 1050 would be used to indicate the automatic selection rather than provide for manual selection.

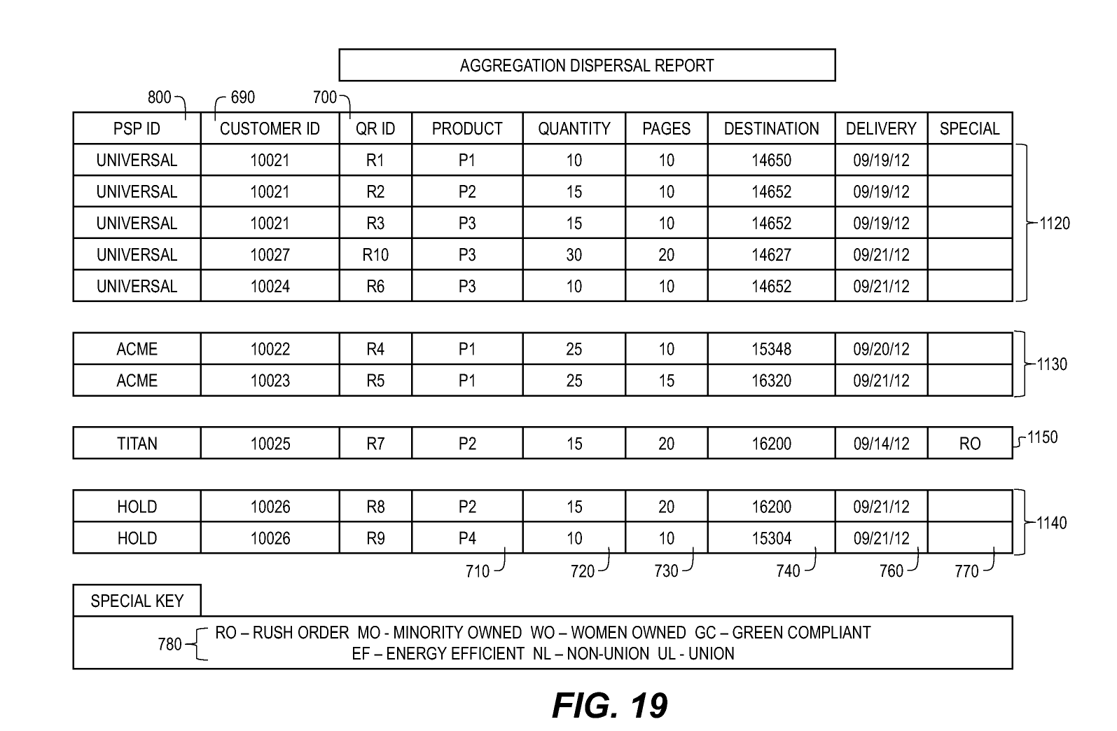

FIG. 19 is a graphic illustrating an aggregation dispersal report data display 1110. The aggregation dispersal report data display 1110 provides a way for an operator to monitor which customer requirements are aggregated and which production/distribution entity 20 is fulfilling which aggregation. Production entity ID data 800 indicates which production/distribution entity 20 will be producing and distributing the aggregation and customer ID data 690 is used to identify the customer making the request. Quoting requirements ID data 700 is associated with the details of the QRs such as product type data 710, product quantity data 720, page quantity data 730, destination data 740, quote delivery data 760, and special data 770. Special data key 780 is provided to interpret and to provide details for the special order code. As illustrated on aggregation dispersal report data display 1110, each aggregation is shown as a group of QRs from one or more customers. Such groupings are shown aggregation 1 1120, aggregation 2 1130, and aggregation 3 1140. Special order 1150 is shown as a single QR with an “RO” designation in the special data column 770. The special data key 780 indicates that the code “RO” stands for “Rush Order” and should be given special consideration.

Aggregation 1 1120 includes QR IDs 700 r1, r2, r3, r10, and r6 is shown with similar destinations 740 as expressed by similar U.S.P.S Zip Codes. The selected production identity ID 800 for aggregation 1 1120 is “Universal” and the selected QRs were aggregated primarily by delivery destination 740. In contrast, aggregation 2 1130 has the same product type data 710 P1 requested by QR IDs r4 and r5 and PSP ID 800 indicates that “Acme” was selected to fulfill the indicated QRs 700. Also note that the destinations 740 aggregation 2 1130 are different indicating that aggregation 2 1130 was aggregated primarily by product type data 710. No production entity has been selected for aggregation 3 1140 as illustrated by the “HOLD” message in the production identity ID column 800 indicating that more compatible QRs are anticipated for this aggregation.

Any or all of the described User Interfaces can be used with the described embodiments and can be used to monitor the aggregator system or to interact with it.

The present invention has been described in detail with particular reference to certain preferred embodiments thereof, but it will be understood that variations and modifications can be effected within the scope of the invention.

### PARTS LIST

10 Aggregator System—Activation Based On Order History
20 Production/Distribution Entities
30 Historic Information Database
40 Historic Information
50 Production/Distribution Pricing Grids
60 Production Service Provider (PSP) Database
80 Customers
90 Quoting Requirement Database
100 Aggregator System Overview without RFEs
110 Timing of Quoting Requirements
120 Quoting Requirements
130 Quotes
140 Aggregator System Overview with RFEs
150 Requests for Estimates
160 Estimates
170 Selection Component
180 Selected Quoting Requirements
190 Aggregation Component
210 Aggregator System-Evaluation Based on Order History w/o RFEs
220 Current Aggregations
230 Anticipated Aggregations
240 Quoting Requirements Prediction Module
250 Anticipated Quoting Requirements
260 Aggregation 1
270 Aggregation 2
280 Aggregator System-Evaluation Based on Order History w/RFE's
290 Price Verification Module
300 Prices to be Verified
310 Aggregator System with Pricing Modifications
320 On-Line Catalog
330 Baseline Estimator Module
340 Target Adjustment Module
350 Baseline
360 Target Cost Estimates
370 Revised Target Cost Estimates
380 Production Capacity Data
390 System Capacity Calculator
400 System Capacity
410 Aggregator System Detailed Overview
420 Constraint Verification Module
430 System and Operator Parameters
440 Hard Criteria
450 Soft Criteria
460 System and Operator Hard Criteria
470 System and Operator Soft Criteria
480 Scenario Generator
490 Scenario Selection Module
500 Best Scenario Selection Module
505 Best Scenario
510 Quote Generation Module
520 Scenarios to be Verified
530 Most Favorable Scenarios
540 Pricing Calculator
560 Aggregation Scenario 1—Diagram
570 Aggregation Scenario 2—Diagram
580 Quoting Requirement 1
590 Quoting Requirement 2
600 Quoting Requirement 3
610 Production/Distribution Entity 1
620 Production/Distribution Entity 2
630 Aggregator System w/Dynamically Updated Catalog Pricing 1
640 Aggregator System w/Dynamically Updated Catalog Pricing 2
650 Initial Pricing
660 Price Adjustment Module
670 Adjusted Quotes
680 Quoting Requirements Database User Interface
690 Customer ID Data
700 Quoting Requirements ID Data
710 Product Type Data
720 Product Quantity Data
730 Page Quantity Data
740 Destination Data
750 Quote Deadline Data
760 Quote Delivery Data
770 Special Data
780 Special Data Key
790 Production Pricing Grid User Interface
800 Production Entity ID Data
810 Production Entity Location Data
820 Amount Data
830 Price Data
840 Distribution Pricing Grid User Interface
850 Shipper Type Data
860 Distance Range Data
870 Weight Range Data
880 Price per Weight Data
890 Historical Database User Interface
900 Orders per Day Data
910 Substrate Type Specification Data
920 Substrate Width Specification Data
930 Substrate Height Specification Data
940 Average Quote Deadline Data (Days)
950 Average Delivery Deadline Data (Days)
960 Expected Items on Order Data Display
970 Volume Axis
980 Day Axis
990 Expected Weight on Order by Destination Data Display
1000 Weight Axis
1010 Day Axis
1020 Total Cost Comparison User Interface
1030 Total Cost Axis
1040 Quoting Requirements Axis
1050 Aggregation Option Selection Bar
1060 Baseline Selection Icon
1070 Aggregation Scenario 1 Icon
1080 Aggregation Scenario 2 Icon
1090 Aggregation Scenario 3 Icon
1100 Aggregation Scenario Key
1110 Aggregation Dispersal Report Data Display
1120 Aggregation 1
1130 Aggregation 2
1140 Aggregation 3
1150 Special Order

1. A method for aggregating multiple customer quoting requirements and selecting appropriate production entities for product production and distribution, comprising:
receiving data from a network of production entities, including at least production and distribution pricing grids;
receiving quoting requirements from a plurality of customers including at least product volumes, product specifications, and delivery time for producing and distributing a plurality of customer designated products;
using a processor and the multiple customer quoting requirements and at least the production and distribution pricing grids from the one or more production entities to produce one or more aggregations of customer orders that satisfy the customer quoting requirements and to concurrently select at least one production entity capable of fulfilling a selected aggregation based on at least one selection criterion; and
sending quotes to the multiple customers using the selected at least one production entity.

2. The method of claim 1 includes using declarative programming or ad hoc algorithms implemented using procedural programming or combinations thereof.

3. The method of claim 2 wherein declarative programming includes answer set programming, constraint based algorithms, satisfiability algorithms, heuristic search algorithms, fuzzy logic algorithms or combinations thereof.

4. The method of claim 1 wherein selection criterion includes production pricing, distribution pricing, availability, or quality requirements.

5. The method of claim 1 wherein the quotes sent to the multiple customers include margin for the aggregator.

6. The method of claim 1 wherein the customer designated products include electronic media products.

7. The method of claim 1 wherein the customer designated products include print media products.
